(19) United States
(12) Patent Application Publication
(10) Pub. No.: US 2026/0361569 A1
(43) Pub. Date: Nov. 12, 2026

(54) CREATION OF NAMESPACE-SCOPED VIRTUAL PRIVATE CLOUDS FOR CONTAINERIZED WORKLOADS IN A MULTI-TENANT NETWORK

(71) Applicant: VMWARE LLC, Palo Alto, CA (US)

(72) Inventors: Danting Liu, Beijing (CN); Xiaopei Liu, Beijing (CN); Jianjun Shen, Redwood City, CA (US); Donghai Han, Beijing (CN); Qian Sun, Beijing (CN)

(73) Assignee: VMware LLC, Palo Alto, CA (US)

(21) Appl. No.: 19/488,790

(22) PCT Filed: Jun. 26, 2023
(86) PCT No.: PCT/CN2023/102356

§ 371 Date: Nov. 28, 2025

(51) Int. Cl. H04L 12/46; H04L 41/0803; H04L 61/5061

(52) U.S. Cl. CPC H04L 12/4641; H04L 41/0803; H04L 61/5061

(57) ABSTRACT

The disclosure provides a method for creating one or more virtual private clouds (VPCs) for containerized workloads within a namespace in a networking environment of a container-based cluster. The method generally includes deploying, on the cluster, a VPC network configuration custom resource specifying network settings for configuring one or more VPCs within the namespace, deploying, on the cluster, a VPC custom resource specifying first parameters for creating a VPC, wherein the first parameters comprise at least an indication of the namespace where the VPC is to be created, and modifying a state of the cluster to match a first intended state of the cluster at least specified in the VPC custom resource and the network configuration custom resource, wherein modifying the state comprises: creating the VPC in the namespace based on the VPC custom resource and configuring the VPC based on the VPC network configuration custom resource.

Modern applications are applications designed to take advantage of the benefits of modern computing platforms and infrastructure. For example, modern applications can be deployed in a multi-cloud or hybrid cloud fashion. A multi-cloud application may be deployed across multiple clouds, which may be multiple public clouds provided by different cloud providers or the same cloud provider or a mix of public and private clouds. The term, “private cloud” refers to one or more on-premises data centers that might have pooled resources allocated in a cloud-like manner. Hybrid cloud refers specifically to a combination of public cloud and private clouds. Thus, an application deployed across a hybrid cloud environment consumes both (1) cloud services executing in a public cloud and (2) local services executing in a private data center (e.g., a private cloud). Within the public cloud or private data center, modern applications can be deployed onto one or more virtual machines (VMs), containers, application services, and/or the like.

A container is a package that relies on virtual isolation to deploy and run applications that depend on a shared operating system (OS) kernel. Containerized applications, also referred to as containerized workloads, can include a collection of one or more related applications packaged into one or more containers. In some orchestration platforms, a set of one or more related containers sharing storage and network resources, referred to as a pod, may be deployed as a unit of computing software. Container orchestration platforms automate the lifecycle of containers, including such operations as provisioning, deployment, monitoring, scaling (up and down), networking, and load balancing.

Kubernetes® (K8S®) software is an example open-source container orchestration platform that automates the deployment and operation of such containerized workloads. In particular, Kubernetes may be used to create a cluster of interconnected nodes, including (1) one or more worker nodes that run the containerized workloads (e.g., in a worker plane) and (2) one or more control plane nodes (e.g., in a control plane) having control plane components running thereon that control the cluster. Control plane components make global decisions about the cluster (e.g., scheduling), and can detect and respond to cluster events (e.g., starting up a new pod when a workload deployment's intended replication is unsatisfied). As used herein, a node may be a physical machine, or a VM configured to run on a physical machine running a hypervisor.

In Kubernetes, namespaces provide a mechanism to further separate clusters into logical units (e.g., virtual sub-clusters). Namespaces help to granularly organize, allocate, manage, and secure cluster resources (e.g., pods). In particular, any resource that exists within Kubernetes exists either in a default namespace (e.g., namespace instantiated, by default, when provisioning a cluster to hold Kubernetes resources) or a namespace that is created by an administrator of the cluster. Any number of namespaces are supported within a cluster, each logically separated from others but with the ability to communicate with each other. Namespaces provide a number of advantages including, isolation thereby allowing workloads for different tenants (e.g., users or customers) to exist in their own virtual clusters without fear of impacting the other's work. Namespaces also enable the use of role-based access controls (RBACs) by limiting users and processes to certain namespaces. Further, namespaces may help to improve performance of a given cluster. For example, where the cluster is separated into multiple namespaces, a Kubernetes application programming interface (API) for the cluster (e.g., Kubernetes API supports retrieving, creating, updating, and deleting primary resources) will have fewer items to search when performing operations. This can reduce latency and increase speed, thereby improving overall workload performance for each containerized workload running in the cluster.

In addition to being namespace isolated (e.g., API and resource isolated), containerized workloads may also need to be network isolated. In particular, in some cases, multiple tenants run containerized workloads in the same networking environment, such as in a public cloud, in the Kubernetes cluster. However, for security purposes, the containerized workloads of different tenants may need to be network isolated from one another within the networking environment. Further, a tenant may be divided into a number of sub-tenants, such that certain containerized workloads of different sub-tenants of a given tenant may also need to be network isolated from one another within the networking environment.

### SUMMARY

One or more embodiments provide a method for creating one or more virtual private clouds for containerized workloads within a namespace in a networking environment of a container-based cluster. The method generally includes deploying, on a container-based cluster, a virtual private cloud network configuration custom resource specifying network settings for configuring one or more virtual private clouds within the namespace. The method generally includes deploying, on the container-based cluster, a virtual private cloud custom resource specifying first parameters for creating a virtual private cloud. The first parameters comprise at least an indication of the namespace where the virtual private cloud is to be created. The method generally includes modifying a state of the container-based cluster to match a first intended state of the container-based cluster at least specified in the virtual private cloud custom resource and the network configuration custom resource. Modifying the state generally includes creating, by the container-based cluster, the virtual private cloud in the namespace based on the parameters specified in the virtual private cloud custom resource. Further, modifying the state generally includes configuring, by the container-based cluster, the virtual private cloud based on the network settings specified in the virtual private cloud network configuration custom resource.

Further embodiments include a non-transitory computer-readable storage medium comprising instructions that cause a computer system to carry out the above methods, as well as a computer system configured to carry out the above methods.

### BRIEF DESCRIPTION OF THE DRAWINGS

FIG. 1A depicts example physical and virtual network components in a networking environment in which embodiments of the present disclosure may be implemented

FIG. 1B illustrates an example cluster for running containerized workloads in the network environment of FIG. 1A, according to an example embodiment of the present disclosure.

FIG. 2 illustrates example operations for creating a virtual private cloud (VPC) in a namespace, according to an example embodiment of the present disclosure.

FIG. 3 illustrates an example VPC network configuration custom resource definition (CRD) template used to specify network settings for configuring VPCs in a namespace of a container-based deployment, according to an example embodiment of the present disclosure.

FIG. 4 illustrates an example VPC CRD used to create a VPC custom resource for instantiating a VPC in a particular namespace of a container-based deployment, according to an example embodiment of the present disclosure.

FIG. 5 illustrates example operations for creating a subnet in a VPC and assigning a workload to the subnet created in the VPC, according to an example embodiment of the present disclosure.

FIG. 6 illustrates an example subnet CRD template used to create a subnet custom resource for a container-based deployment, according to an example embodiment of the present disclosure.

FIG. 7 illustrates an example subnet port CRD used to assign a workload to a subnet in a container-based deployment, according to an example embodiment of the present disclosure.

FIG. 8 illustrates example isolation constructs implemented to provide basic isolation capabilities for networking and security in multi-tenancy architecture, according to an example embodiment of the present disclosure.

FIG. 9 illustrates an example SubnetSet CRD template used to create a subnet custom resource for a container-based deployment, according to an example embodiment of the present disclosure.

FIG. 10 illustrates an example internet protocol (IP) pool CRD used to allocate a range of IP addresses belonging to a VPC's IP pool, according to an example embodiment of the present disclosure.

FIG. 11 illustrates an example static route CRD used to create a static route custom resource to allow a network interface from nodes on one subnet to reach nodes on another network, according to an example embodiment of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Techniques for providing isolation constructs to network isolate nodes running containerized workloads in a container-based cluster, such as a Kubernetes cluster, are described herein. In certain embodiments, the isolation constructs include organizations (orgs), projects, and virtual private clouds (VPCs) organized in a hierarchy. In particular, an organization includes one or more projects, and a project includes one or more VPCs. An org may be associated with a particular tenant, such that different tenants are associated with different orgs. Further, a project may be associated with a sub-tenant of the tenant associated with the org that includes the project, such that different sub-tenants are associated with different projects. A VPC is a logically isolated section of the multi-tenant networking environment. More specifically, a VPC is a representation of a virtual network, with on-demand configurable network services and a pool of resources.

In certain embodiments, each VPC is created for a particular namespace (e.g., each VPC is namespace-scoped), and each namespace may have one or more VPCs (e.g., a default VPC and, in some cases, one or more other user-created VPCs). As described above, Kubernetes resources are assigned to different namespaces to help isolate, organize, and manage cluster resources, as well as improve overall workload performance. To support existing namespace constructs for API and resource isolation between users, embodiments described herein involve creating VPCs for different namespaces. For example, a VPC created for a particular namespace is a virtual isolated network defined for the namespace that is used to control how resources created for and assigned to the namespace are exposed to the Internet. Example security features provided by the VPC to secure resources in the namespace include security groups (e.g., virtual firewalls to control ingress and egress traffic at an instance level), network access control lists (ACLs) that allow and/or deny specify inbound or outbound traffic at a subnet level within the VPC, VPC flow logs used to capture information about internet protocol (IP) traffic going to and from network interfaces in the VPC, routing tables containing a set of rules used to determine where network traffic is directed, and/or the like. Creating the VPC in the namespace to realize these security features involves creating the private cloud network by assigning an IP address range to it and associating the private cloud network with the namespace. As such, resources (e.g., pods, nodes, workloads, etc.) created and assigned to the namespace may be launched within the range of IP addresses assigned to the VPC. In other words, these resources, when created, are scoped under the VPC created for (e.g., associated with) the namespace, such that these resources realize security features provided by the VPC and are able to consume local networking services provided by the particular VPC. The resources of a given VPC may share the same security, availability, and communication requirements.

To create the different namespace-scoped VPCs, embodiments herein provide two new custom resource definitions (CRDs), used to create two new custom resource objects (also referred to herein as “custom resources”) in a Kubernetes cluster. In particular, a Kubernetes platform is made up of a central database containing Kubernetes objects, or persistent entities, that are managed in the platform. Kubernetes objects are represented in configuration files, such as JavaScript Object Notation (JSON) or YAML files, and describe the intended state of a Kubernetes cluster of interconnected nodes used to run containerized workloads. A Kubernetes object is a “record of intent”—once an object is created, the Kubernetes system will constantly work to ensure that object is realized in the deployment. One type of Kubernetes object used to define the intended state of the cluster includes custom resources. A custom resource is an object that extends the Kubernetes application programming interface (API) or allows a user to introduce their own API into a Kubernetes cluster. For example, a user may generate a custom resource definition (CRD), such as in a YAML file, and the CRD can be used to create the custom resource in the cluster. Instances of the custom resource can then be deployed in the cluster.

A first custom resource provided herein includes a VPC custom resource. A cluster where the VPC custom resource is deployed may use the custom resource to create VPC instance(s) in the cluster. The VPC custom resource may be created via a VPC CRD generated by a user, and the user may specify in the VPC CRD a namespace where VPC instance(s) are to be created, for this custom resource, such that the VPC instance(s) are created in the specified namespace (e.g., each VPC is namespace-scoped).

A second custom resource provided herein includes a VPC network configuration custom resource (e.g., created via a VPC network configuration CRD generated by a user). The VPC network configuration custom resource specifies network settings for configuring one or more VPCs in a namespace. A VPC network configuration custom resource may be created per namespace such that VPCs created for different namespaces are configured with different network settings. The VPC network configuration custom resource, when deployed, causes the cluster manager to configure VPCs in namespace based on the network settings specified in the VPC network configuration custom resource created for the namespace.

As such, techniques described herein provide a solution for creating isolated networking environments, e.g., VPCs, for Kubernetes resources (e.g., pods, nodes, etc.) given the existing namespace infrastructure implemented for a Kubernetes cluster. The different custom resources allow for the efficient deployment and configuration of namespace-scoped VPCs in the cluster.

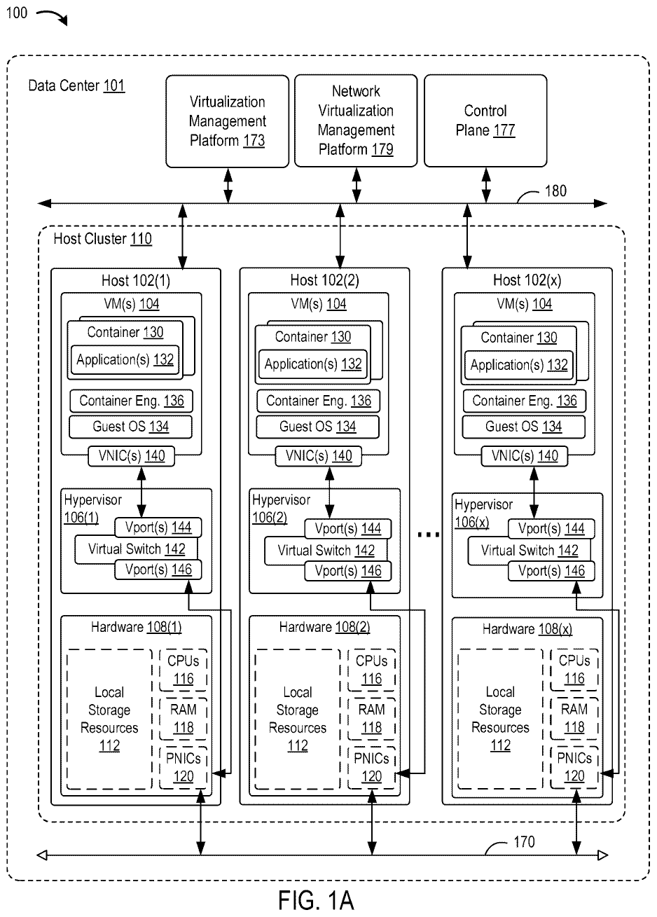

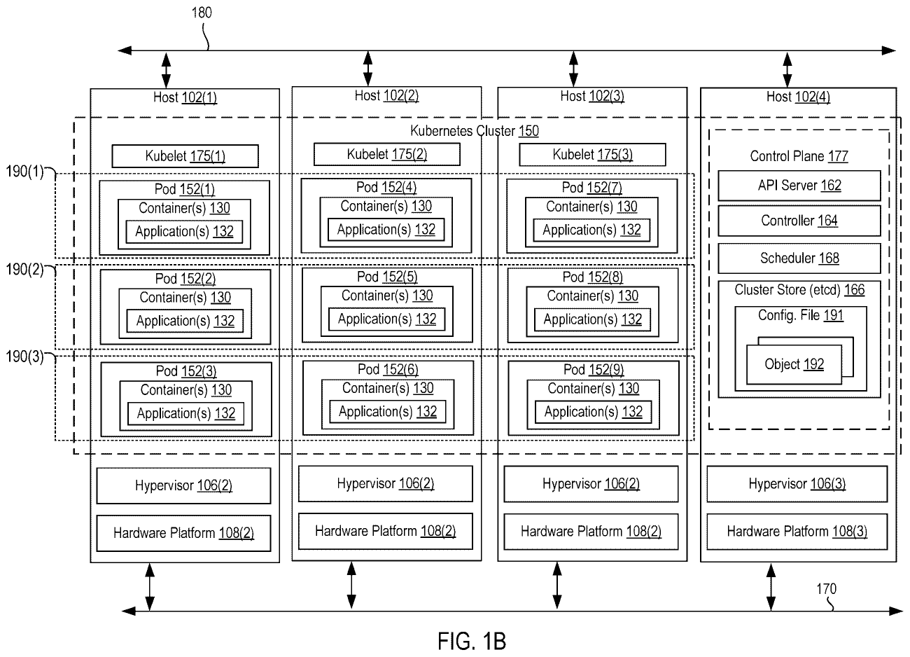

FIG. 1A depicts example physical and virtual network components in a networking environment 100 in which embodiments of the present disclosure may be implemented. Networking environment 100 includes a data center 101. Data center 101 includes one or more hosts 102, a management network 180, a data network 170, a virtualization management platform 173, a network virtualization management platform 179, and a control plane 177.

Host(s) 102 may be communicatively connected to management network 180 and data network 170. Data network 170 and management network 180 enables communication between hosts 102, and/or between other components and hosts 102.

Data network 170 and management network 180 may be separate physical networks or may be logically isolated using a single physical network and separate VLANs or logical overlay networks, or a combination thereof. As used herein, the term “underlay” may be synonymous with “physical” and refers to physical components of networking environment 100. As used herein, the term “overlay” may be used synonymously with “logical” and refers to the logical network implemented at least partially within networking environment 100.

Host(s) 102 may be geographically co-located servers on the same rack or on different racks in any arbitrary location in the data center. Host(s) 102 may be in a single host cluster or logically divided into a plurality of host clusters. Each host 102 may be configured to provide a virtualization layer, also referred to as a hypervisor 106, that abstracts processor, memory, storage, and networking resources of a hardware platform 108 of each host 102 into multiple VMs 1041 to 104N (collectively referred to as VMs 104 and individually referred to as VM 104) that run concurrently on the same host 102.

Host(s) 102 may be constructed on a server grade hardware platform 108, such as an x86 architecture platform. Hardware platform 108 of each host 102 includes components of a computing device such as one or more processors (central processing units (CPUs)) 116, memory (random access memory (RAM)) 118, one or more network interfaces (e.g., physical network interfaces (PNICs) 120), storage 112, and other components (not shown). CPU 116 is configured to execute instructions that may be stored in memory 118, and optionally in storage 112. The network interface(s) enable hosts 102 to communicate with other devices via a physical network, such as management network 180 and data network 170.

In certain embodiments, hypervisor 106 runs in conjunction with an operating system (OS) (not shown) in host 102. In some embodiments, hypervisor 106 can be installed as system level software directly on hardware platform 108 of host 102 (often referred to as “bare metal” installation) and be conceptually interposed between the physical hardware and the guest operating systems executing in the VMs 104. It is noted that the term “operating system,” as used herein, may refer to a hypervisor.

Each of VMs 104 running on each host 102 may include virtual interfaces, often referred to as virtual network interfaces (VNICs), such as VNICs 140, which are responsible for exchanging packets between VMs 104 and hypervisor 106, such as with a virtual switch 142 running in the hypervisor 106. The virtual switch on each host operates as a managed edge switch implemented in software by a hypervisor on each host. Virtual switches provide packet forwarding and networking capabilities to VMs running on the host. VNICs 140 can connect to Vports 144, provided by virtual switch 142. In this context “connect to” refers to the capability of conveying network traffic, such as individual network packets, or packet descriptors, pointers, identifiers, etc., between components so as to effectuate a virtual datapath between software components. Virtual switch 142 also has Vport(s) 146 connected to PNIC(s) 120, such as to allow VMs 104 (and containers 130 running in VMs 104, as described below) to communicate with virtual or physical computing devices outside of host 102 via data network 170 and/or management network 180.

Further, each of VMs 104 implements a virtual hardware platform that supports the installation of a guest OS 134 which is capable of executing one or more applications 132. Guest OS 134 may be a standard, commodity operating system. Examples of a guest OS include Microsoft Windows, Linux, and/or the like. Applications 132 may be any software program, such as a word processing program.

Network virtualization management platform 179 is a physical or virtual server that orchestrates a software-defined network layer. A software-defined network layer includes logical network services executing on virtualized infrastructure (e.g., of hosts 102). The virtualized infrastructure that supports logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches and logical routers, as well as logical firewalls, logical virtual private networks (VPNs), logical load balancers, and the like, implemented on top of the virtualized infrastructure.

In certain embodiments, network virtualization management platform 179 includes one or more virtual servers deployed as VMs. In certain embodiments, network virtualization management platform 179 installs agents in hypervisor 106 to add a host 102 as a managed entity, referred to as an edge transport node. An edge transport node may be a gateway (e.g., implemented by a router) between the internal logical networking of hosts 102 and an external network. Data Center 101 also includes physical network devices (e.g., physical routers/switches), which are not explicitly shown in FIG. 1.

One example of a software-defined networking platform that can be configured and used in embodiments described herein as network virtualization management platform 179 and the software-defined network layer is a VMware NSX® platform made commercially available by VMware, Inc. of Palo Alto, California.

Virtualization management platform 173 is a computer program that executes in a host 102 in data center 101, or alternatively, virtualization management platform 173 runs in one of VMs 104. Virtualization management platform 173 is configured to carry out administrative tasks for data center 101, including managing hosts 102, managing (e.g., configuring, starting, stopping, suspending, etc.) VMs 104 running within each host 102, provisioning VMs 104, transferring VMs 104 from one host 102 to another host 102, and/or the like.

In certain embodiments, data center 101 includes a container orchestrator that implements an orchestration control plane 177 (also referred to herein as “control plane 177”), such as a Kubernetes control plane, to deploy and manage applications 132 and/or services thereof on hosts 102, of a host cluster 110, using containers 130. In particular, each VM 104 includes a container engine 136 installed therein and running as a guest application under control of guest OS 134. Container engine 136 is a process that enables the deployment and management of virtual instances, referred to herein as “containers,” in conjunction with OS-level virtualization on guest OS 134 within VM 104 and the container orchestrator. Containers 130 provide isolation for user-space processes executing within them. Containers 130 encapsulate an application 132 (and its associated workloads) as a single executable package of software that bundles application code together with all of the related configuration files, libraries, and dependencies required for it to run.

Control plane 177 runs on a cluster of hosts 102 and may deploy containerized applications as containers 130 on the cluster of hosts 102. Control plane 177 manages the computation, storage, and memory resources to run containers 130 in the host cluster. Further, control plane 177 supports the deployment and management of applications (or services) in the container-based cluster using containers 130. In certain embodiments, hypervisor 106 is integrated with control plane 177 to provide a “supervisor cluster” (i.e., management cluster) that uses VMs 104 to implement both control plane nodes and compute objects managed by control plane 177 (e.g., Kubernetes control plane).

In certain embodiments, control plane 177 deploys applications 132 as pods of containers running on hosts 102, either within VMs 104 or directly on an OS of hosts 102. A pod is a group of one or more containers 130 and a specification for how to run the containers 130. A pod may be the smallest deployable unit of computing that can be created and managed by control plane 177.

An example container-based cluster for running containerized applications 132 is illustrated in FIG. 1B. While the example container-based cluster shown in FIG. 1B is a Kubernetes cluster 150, in other examples, the container-based cluster may be another type of container-based cluster based on container technology, such as Docker Swarm clusters.

As illustrated in FIG. 1B, Kubernetes cluster 150 is formed from a combination of one or more pods 152 including one or more containers 130, one or more kubelets 175, and a control plane 177 running on one or more nodes. As described above, a node may be a physical machine, such as a host 102, or a VM 104 (not shown in FIG. 1B) configured to run on a host 102 running a hypervisor 106. The nodes may be a combination of worker nodes (e.g., running pods 152, containers 130, and kubelets 175) and control plane nodes (e.g., running components of control plane 177). For the example Kubernetes cluster 150, the nodes are hosts 102, and more specifically, hosts 102(1), 102(2), and 102(3) are worker nodes while host 102(4) is a control plane node.

Further, although not illustrated in FIG. 1B, Kubernetes cluster 150 may include one or more kube proxies. A kube proxy is a network proxy that runs on each host 102 in Kubernetes cluster 150 that is used to maintain network rules. These network rules allow for network communication with pods 152 from network sessions inside and/or outside of Kubernetes cluster 150.

Pods 152 and/or containers 130 may be organized into one or more namespaces 190 in Kubernetes cluster 150. For example, as illustrated, pods 152(1), 152(4), and 152(7), as well as containers 130 running thereon, belong to a first namespace 190(1), while other pods 152 and containers 130 belong to one of namespace 190(2) or namespace 190(3). As described above, namespaces help to provide API and resource isolation between user applications 132 in Kubernetes cluster 150.

Kubelet 175 (e.g., on each worker node) is an agent that helps to ensure that one or more pods 152 run on each worker node according to a defined state for the pods 152, such as defined in a configuration file. Each pod 152 may include one or more containers 130.

Control plane 177 (e.g., running on control plane node(s)) includes components such as an API server 162, a cluster store (etcd) 166, controller(s) 164, and scheduler(s) 168. Control plane 177's components make global decisions about Kubernetes cluster 150 (e.g., scheduling), as well as detect and respond to cluster events. Control plane 177 manages and controls every component of Kubernetes cluster 150. Control plane 177 handles most, if not all, operations within Kubernetes cluster 150, and its components define and control Kubernetes cluster 150's configuration and state data. Control plane 177 configures and runs the deployment, management, and maintenance of the containerized applications 132. As such, ensuring high availability of the control plane 177 is important for container deployment and management.

API server 162 operates as a gateway to Kubernetes cluster 150. As such, a command line interface, web user interface, users, and/or services communicate with Kubernetes cluster 150 through API server 162. One example of a Kubernetes API server 162 is kube-apiserver. Instances of kube-apiserver are designed to scale horizontally-that is, this component scales by deploying more instances. Several instances of kube-apiserver may be run, and traffic may be balanced between those instances.

Controller(s) 164 is responsible for running and managing controller processes in Kubernetes cluster 150. For example, control plane 177 may have (e.g., four) control loops called controller processes, that watch the state of Kubernetes cluster 150 and try to modify the current state of Kubernetes cluster 150 to match an intended state of Kubernetes cluster 150. In certain embodiments, controller processes of controller(s) 164 are configured to monitor for changes to the state of Kubernetes cluster 150.

Scheduler(s) 168 is configured to allocate new pods 152 to the worker nodes (e.g., hosts 102). Additionally, scheduler(s) 168 may be configured to distribute applications 132, across containers 130, pods 152, and/or nodes (e.g., in some cases, hosts 102) that are assigned to use resources of hardware platform 108. Resources may refer to processor resources, memory resources, networking resources, and/or the like. In some cases, scheduler(s) 168 may schedule newly created containers 130 to one or more of the nodes in Kubernetes cluster 150.

Cluster store (etcd) 166 is a data store, such as a consistent and highly-available key value store, used as a backing store for Kubernetes cluster 150 data. In certain embodiments, cluster store (etcd) 166 stores configuration file(s) 191, made up of one or more manifests, that declare intended system infrastructure and applications 132 to be deployed in Kubernetes cluster 150. Kubernetes objects 192, or persistent entities, can be created, updated, and deleted based on configuration file(s) 191 to represent the state of Kubernetes cluster 150.

As described above, these objects may be custom resources (e.g., custom resource objects created based on CRDs generated by a user), such as VPC network configuration custom resources and VPC custom resources, created specifically for Kubernetes cluster 150. The VPC custom resources may be used to create VPC instances in different namespaces 190 (e.g., namespace-scoped VPCs) in Kubernetes cluster 150. Additionally, the VPC network configuration custom resources may be used to specify network settings for configuring one or more VPCs in different namespaces 190.

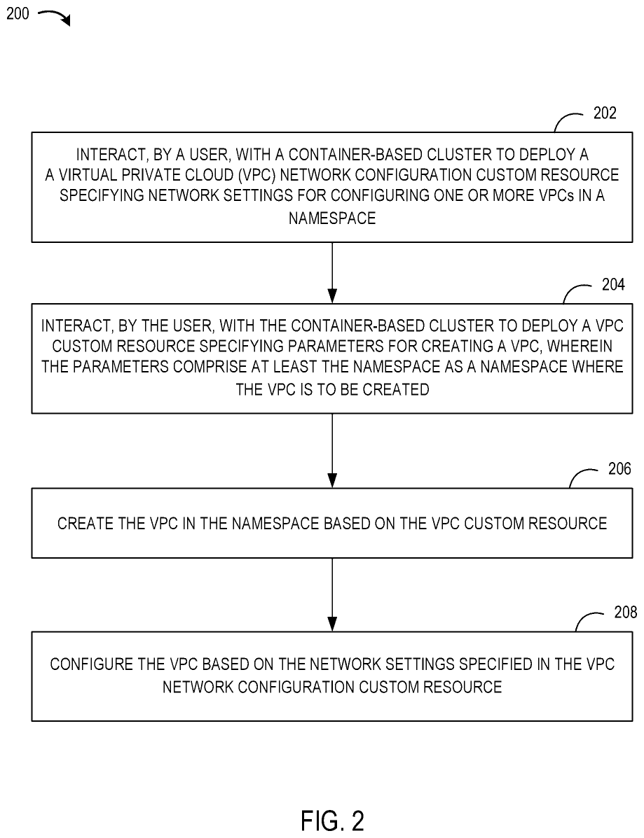

FIG. 2 illustrates example operations 200 for creating a VPC in a namespace 190 in Kubernetes cluster 150. Kubernetes cluster 150 may be a multi-tenant cluster shared among multiple tenants. In the shared infrastructure, isolated networking and security topologies may be provisioned for each of the different tenants. For example, orgs, projects, and VPCs (e.g., using a VPC custom resource and a VPC network configuration custom resource) may be implemented to provide basic isolation capabilities for networking and security among the tenants, their sub-tenants, and Kubernetes resources deployed in different namespaces 190 in Kubernetes cluster 150.

Operations 200 begin, at operation 202, by a user interacting with a container-based cluster (e.g., in this example, Kubernetes cluster 150) to deploy a VPC network configuration custom resource. The VPC network configuration custom resource specifies network settings for configuring one or more VPCs in a namespace (e.g., such as namespace 190(1), 190(2), or 190(3) in FIG. 1B) in Kubernetes cluster 150.

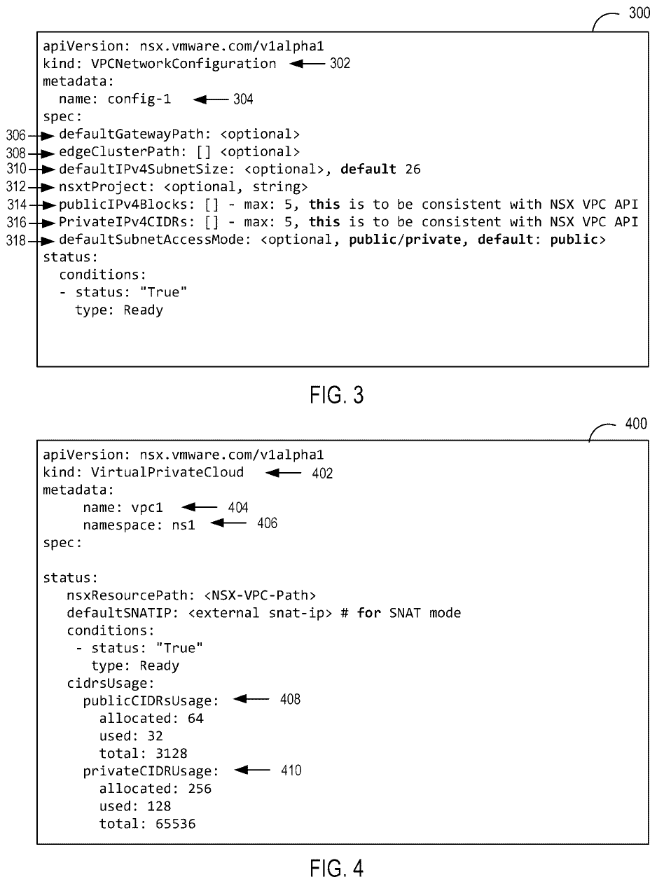

In certain embodiments, the user deploys the VPC network configuration custom resource by generating a VPC network configuration CRD (e.g., a configuration file 191) and providing the CRD to Kubernetes cluster 150. FIG. 3 illustrates an example VPC network configuration CRD template 300 used to specify network settings for configuring a VPC in a namespace.

As illustrated, example CRD template 300 is used to define a VPC network configuration custom resource (e.g., type of custom resource defined as “kind: VPCNetworkConfiguration” at 302) named “config-1” (e.g., shown at 304). VPC network configuration CRD template 300 defines, in a declarative way, a desired network configuration for VPCs created in Kubernetes cluster 150. For example, a user may generate a VPC network configuration CRD using example CRD template 300 to declare intended network properties for configuring VPCs, when created. As shown at 306-312 and 318, respectively, intended network properties defined in the VPC network configuration CRD may include an intended default gateway path for a VPC, an intended edge cluster path for a VPC, a default subnet size for subnets created within a VPC (e.g., where a subnet is a logical partition of an internet protocol (IP) network), a network virtualization management platform (e.g., “nsxtProject”), and/or a default subnet access/connectivity mode for subnets created within a VPC. Different subnet connectivity modes include a private connectivity mode, a project connectivity mode, and a public connectivity mode, and are described in detail below. Further, at 314 and 316, a user may specify public IP block(s), having a plurality of public IP addresses, to assign to a VPC when created, as well as, private IP classless inter-domain routing (CIDR) blocks, having a plurality of private IP addresses, to assign to a VPC when created. It is noted that example VPC network configuration CRD 300 is an example CRD and not all fields (e.g., intended network properties) that a user is able to define in such a CRD, are illustrated in FIG. 3.

Although not illustrated in FIG. 3, in certain embodiments, a user may further specify in the VPC network configuration CRD a namespace that the CRD is to be associated with. For example, different VPC network configuration custom resources may be created for different namespaces. As such, VPCs created in a first namespace may be configured with network settings defined in a VPC network configuration custom resource, created from a CRD associated with the first namespace, while VPCs created in a second namespace may be configured with network settings defined in a VPC network configuration custom resource, created from a CRD associated with the second namespace. VPCs created in the first namespace and VPCs created in the second namespace may have one or more different network configurations and/or settings.

Returning to FIG. 2, operations 200 proceed, at operation 204, with the user further interacting with the container-based cluster to deploy a VPC custom resource. The VPC custom resource specifies parameters for creating a VPC. The parameters include at least a namespace in the container-based cluster where a VPC instance of the VPC custom resource is to be created, such that the VPC, when created, is namespace-scoped.

In certain embodiments, the user deploys the VPC custom resource by generating a VPC CRD (e.g., a configuration file 191) and providing the CRD to Kubernetes cluster 150. FIG. 4 illustrates an example VPC CRD 400 used to specify parameters for creating a VPC in a namespace.

As illustrated, example VPC CRD 400 is used to define a VPC custom resource (e.g., type of custom resource defined as “kind: VirtualPrivateCloud” at 402) in Kubernetes cluster 150. VPC CRD 400 includes fields for specifying a name, for example, “vpc1,” and a namespace, for example, “ns1,” for the VPC, at 404 and 406 respectively. Further, at 408 and 410, VPC CRD 400 may include information about public CIDR usage and private CIDR usage by the VPC, respectively.

Returning to FIG. 2, operations 200 proceed, at operation 206, with creating a VPC (e.g., also referred to herein as a VPC instance) in a namespace based on the VPC custom resource (e.g., created from the VPC CRD). For example, a controller in Kubernetes cluster 150 (e.g., controller 164 in FIG. 1B) may determine that the state of Kubernetes cluster 150 has changed when the VPC custom resource is created, and in response to making this determination, work to modify the state of Kubernetes cluster 150 to match the new intended state of the cluster, where the new intended state includes the creation of the VPC instance based on the VPC custom resource deployed. As such, the VPC instance may be created in Kubernetes cluster 150, specifically in a namespace specified in the VPC custom resource.

Operations 200 proceed, at operation 208, with configuring the VPC (e.g., created at operation 206) based on the network settings specified in the VPC network configuration custom resource (e.g., deployed at operation 202).

Operations 200 may be repeated to create and configure additional VPCs in a same namespace or different namespaces in Kubernetes cluster 150. As such, each created VPC may be namespace-scoped and thus, support existing namespace constructs for API and resource isolation between users.

In certain embodiments, different connectivity mode subnets are created for each created VPC (e.g., using operations 200). Example connectivity mode subnets may include a private connectivity mode subnet (also referred to as a private subnet), a project connectivity mode subnet (also referred to as a project subnet), or a public connectivity mode subnet (also referred to as a public subnet). Nodes in Kubernetes cluster 150 may be assigned to the different subnets of different VPCs by assigning IP addresses from a given CIDR block associated with each of the subnets to the nodes belonging to each of the subnets.

Nodes assigned to the private connectivity mode subnet are assigned IP addresses from a private IP CIDR block associated with the private connectivity mode subnet. Each IP address of the private IP CIDR block is guaranteed unique only within the VPC itself, and not across VPCs. Therefore, a node assigned to the private connectivity mode subnet is only directly addressable by its assigned IP address from the private IP CIDR block within the VPC itself. For the node to be addressable outside the VPC, network address translation (NAT) must be used.

Nodes assigned to the project connectivity mode subnet are assigned IP addresses from a project IP CIDR block associated with the project connectivity mode subnet. Each IP address of the project IP CIDR block is guaranteed unique across all VPCs within the project itself, and not across projects. Therefore, a node assigned to the project connectivity mode subnet is only directly addressable by its assigned IP address from the project IP CIDR block within the project itself. For the node to be addressable outside the project, NAT must be used.

Nodes assigned to the public connectivity mode subnet are assigned IP addresses from a public IP CIDR block associated with the public connectivity mode subnet. Each IP address of the public IP CIDR block is guaranteed unique across all VPCs within the org. Therefore, a node assigned to the public connectivity mode subnet is directly addressable by its assigned IP address from the public IP CIDR block within the org itself. For the node to be addressable outside the org, NAT must be used. Each connectivity mode subnet, therefore, provides a different level of network isolation, namely at the VPC level, project level, or org level.

To create the different connectivity mode subnets, described above, in different VPCs, as well as assign nodes (and accordingly containerized workloads running on the nodes) to each of these subnets, embodiments herein provide two CRDs. More specifically, a first CRD includes a subnet CRD that allows a user to define a subnet custom resource for creating subnet instances in Kubernetes cluster 150, and further a connectivity mode for the subnet instance created from the subnet custom resource. A second CRD includes a subnet port CRD that allows a user to define a subnet port custom resource for a node, such as a VM. The subnet port custom resource may be generated to associate the node, and containerized workloads running thereon, with a particular subnet.

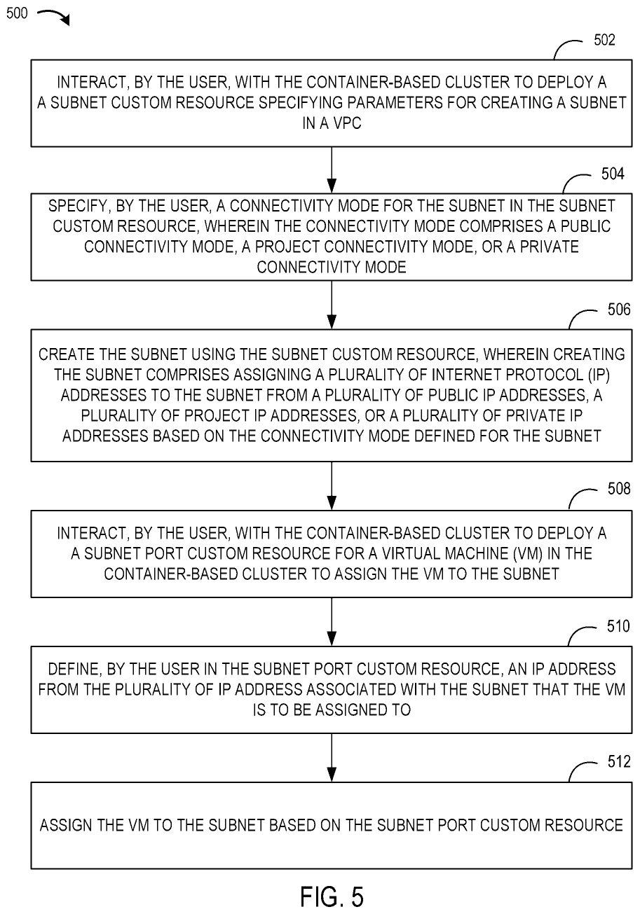

FIG. 5 illustrates example operations 500 for creating a subnet in a VPC, in Kubernetes cluster 150, and assigning a workload to the subnet created in the VPC. Similar to operations 200 of FIG. 2 describe above, Kubernetes cluster 150 may be a multi-tenant cluster shared among multiple tenants. In the shared infrastructure, isolated networking and security topologies may be provisioned for each of the different tenants. For example, orgs, projects, VPCs, and subnets may be implemented to provide basic isolation capabilities for networking and security among the tenants, their sub-tenants, and applications 132 in Kubernetes cluster 150.

Operations 500 begin, at operation 502, by a user interacting with a container-based cluster to deploy a subnet custom resource specifying parameters for creating a subnet in a VPC. The subnet custom resource is defined by a user via a subnet CRD (e.g., a configuration file 191). Defining a subnet custom resource may be accomplished in various ways. For example, in certain embodiments, defining the subnet custom resource includes identifying and/or specifying different attributes (e.g., including a connectivity mode, as described in operation 504) of the subnet that is to be created in the VPC, for example, defining such attributes in a configuration file. As another example, in certain embodiments, defining the subnet custom resource includes selecting a pre-existing subnet custom resource, with its attributes defined. For example, a user may select a pre-existing subnet custom resource via a graphical user interface (GUI).

Operations 500 proceed, at operation 504, by specifying a connectivity mode for the subnet in the subnet custom resource (e.g., via the subnet CRD). The specified connectivity mode may be a public connectivity mode, a project connectivity mode, or a private connectivity mode.

Operations 500 proceed, at operation 506, by creating the subnet using the subnet custom resource. In particular, once the subnet custom resource is deployed, the system will work to ensure that the subnet defined by the subnet custom resource is realized in the deployment. Creation of the subnet includes assigning IP addresses to the subnet from a plurality of public IP addresses, a plurality of project IP addresses, or a plurality of private IP addresses based on the connectivity mode specified for the subnet in the subnet custom resource.

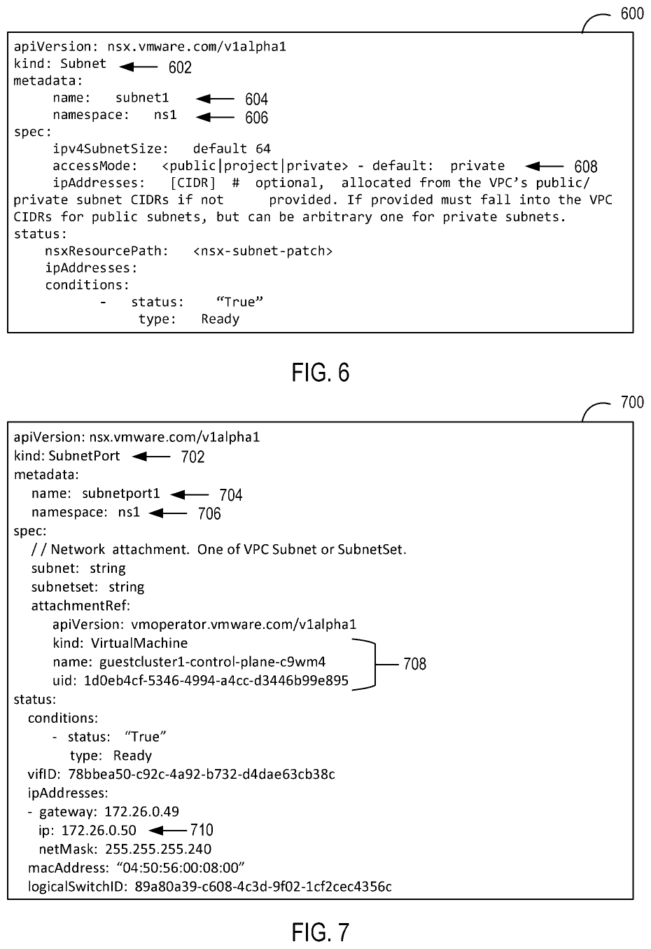

FIG. 6 illustrates an example subnet CRD template 600 used to create a subnet custom resource for Kubernetes cluster 150 in operations 500 (e.g., type of custom resource defined as “kind: Subnet” at 602). As illustrated at 604 and 606, example subnet CRD template 600 includes fields for specifying a name, for example, “subnet1,” and a namespace, for example, “ns1,” for the subnet. Further, subnet CRD template 600 may include a field, “accessMode” at 608, for specifying a connectivity mode of the subnet custom resource. The subnet created from the subnet custom resource may be created with a public, project, or private connectivity mode as illustrated by “accessMode: <public|project|private>” at 608. In some cases, IP addresses to be assigned to the subnet may be specified by a user in subnet CRD template 600. In cases where a user does not specify the IP addresses, IP addresses from a plurality of public IP addresses, a plurality of project IP addresses, or a plurality of private IP addresses are allocated to the subnet object based on the “accessMode” indicated in subnet CRD template 600.

Returning to FIG. 5, operations 500 proceed, at operation 508, by a user interacting with the container-based cluster (e.g., Kubernetes cluster 150) to deploy a subnet port custom resource specifying parameters for a VM 104 in the cluster to assign the VM 104 to the subnet (e.g., created at operation 506). The subnet port custom resource is defined by a user via a subnet port CRD (e.g., a configuration file 191). Defining a subnet port custom resource may be accomplished in various ways. For example, in certain embodiments, defining the subnet port custom resource includes identifying and/or specifying different attributes of the subnet port custom resource, for example, defining such attributes in a configuration file 191. As another example, in certain embodiments, defining the subnet port custom resource includes selecting a pre-existing subnet port custom resource, with its attributes defined. For example, a user may select a pre-existing subnet port custom resource via a GUI.

Operations 500 proceed, at operation 510, by defining an IP address from a plurality of IP addresses in a CIDR block associated with a subnet that the VM 104 is to be assigned to. The user specifies the IP address for the subnet port custom resource via the subnet port CRD.

Operations 500 proceed, at operation 512, by assigning the VM 104 to the subnet based on deployment of the subnet port custom resource. Creation of the subnet port custom resource assigns the VM 104 to the intended subnet (e.g., having a public, project, or private connectivity mode) by assigning the specified IP address to the VM 104. In other words, once the subnet port custom resource is created, the system will work to ensure that the VM 104 that is to be assigned to the subnet defined by the subnet port custom resource is realized in the deployment.

FIG. 7 illustrates an example subnet port CRD 700 used to create a subnet port custom resource for Kubernetes cluster 150 in operations 500 (e.g., type of custom resource defined as “kind: SubnetePort” at 702). As illustrated at 704 and 706, example subnet port CRD 700 is used to create a subnet port custom resource named “subnetport1” in namespace “ns1.” The subnet port custom resource may be created to assign the VM 104 with name “guestcluster1-control-plane-c9wm4” and uid “1d0eb4cf-5346-4994-a4cc-d3446b99e895” to a particular subnet, as illustrated at 708. The subnet for which VM 104 is assigned is based on the IP address specified at 710 in subnet port CRD 700. For example, as shown, the IP address to be assigned to VM 104 is “172.26.0.50.” For this example, IP address “172.26.0.50” may be an IP address selected among a plurality of IP addresses in an IP address CIDR block associated with a project subnet (e.g., CIDR block 172.26.0.48/28). As such, based on assigning VM 104 IP address “172.26.0.50,” VM 104 is assigned to the project subnet (e.g., where the subnet is created within a VPC).

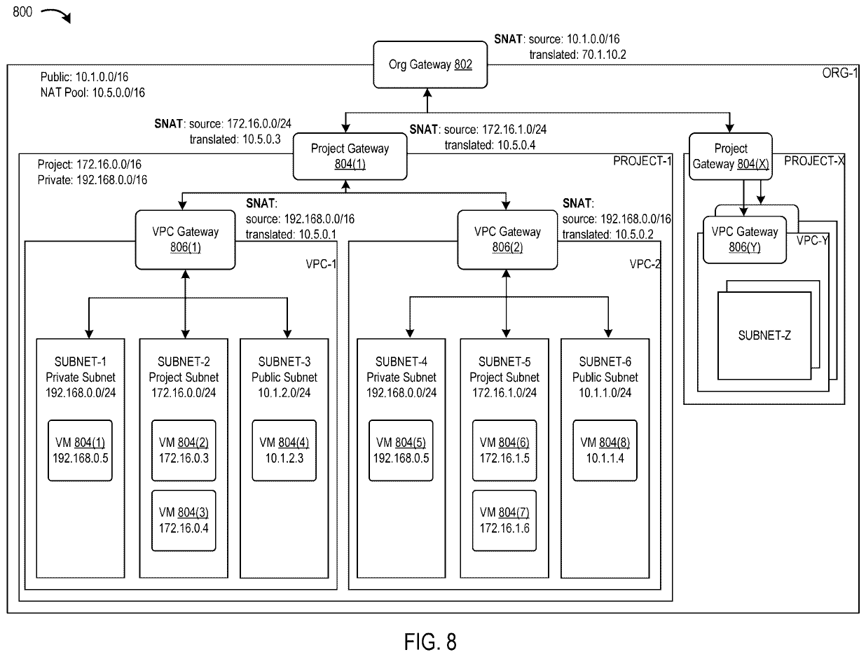

FIG. 8 illustrates example isolation constructs implemented to provide basic isolation capabilities for networking and security in a multi-tenancy architecture 800. Although multi-tenancy architecture 800 only illustrates a single org corresponding to a single tenant, other orgs with similar constructs may be created for other tenants in multi-tenancy architecture 800.

As illustrated in FIG. 4, the isolation constructs implemented for networking and security isolation in multi-tenancy architecture 800 include orgs (although only one is illustrated in FIG. 8, other orgs may exist), projects, VPCs (e.g., namespace-scoped VPCs), and subnets.

The illustrated org corresponds to a single tenant in architecture 800. The org may include one or more projects (e.g., {Project-1, . . . , Project-X}). Each project is associated with a sub-tenant of a tenant corresponding to the org. Projects are created under each org to support independent sets of configurations for each tenant. Each org (shown as org-1) is associated with an org gateway 802. Each project (shown as project-1 and project-X) is associated with a project gateway 804. Each VPC (shown as VPC-1, VPC-2, and VPC-Y) is associated with a VPC gateway 806. Further, according to techniques described herein, each VPC is created within a particular namespace (although namespaces are omitted from architecture 800).

Each project is a container of VPCs. In particular, each project may include one or more VPCs, such as example Project-1 which includes {VPC-1, VPC-2} in architecture 800.

Each VPC includes one or more subnets. The number of subnets created per VPC may depend on a number of subnet objects defined (e.g., via subnet custom resources) for architecture 800. The subnets may be public subnets, project subnets, and/or private subnets. For example, VPC-1 includes subnet-1 (a private subnet), subnet-2 (a project subnet), and subnet-3 (a public subnet). VPC-2 includes subnet-4 (a private subnet), subnet-5 (a project subnet), and subnet-6 (a public subnet).

In the example architecture, IP addresses in private IP CIDR block 192.168.0.0/16 are reserved for private subnets in each given VPC of the org. For example, all IP addresses in private IP CIDR block 192.168.0.0/16 can be assigned to VMs in VPC-1, and all IP addresses in private IP CIDR block 192.168.0.0/16 can also be assigned to VMs in VPC-2, such that a VM in VPC-1 and a VM in VPC-2 can have the same IP address from private IP CIDR block 192.168.0.0/16. Each private subnet is allocated one or more IP addresses from the private IP CIDR block 192.168.0.0/16. For example, subnet-1 of VPC-1 is allocated IP addresses in CIDR block 192.168.0.0/24, which is a portion of the IP addresses in the private CIDR block 192.168.0.0/16. Further, subnet-4 of VPC-2 is also allocated IP addresses in CIDR block 192.168.0.0/24, as the same IP addresses can be assigned to VMs in different VPCs.

Further, in the example architecture, IP addresses in project IP CIDR block 172.16.0.0/16 are reserved for project subnets in each given project of the org. For example, all IP addresses in project IP CIDR block 172.16.0.0/16 can be assigned to VMs in project-1, and all IP addresses in project IP CIDR block 172.16.0.0/16 can also be assigned to VMs in project-X, such that a VM in project-1 and a VM in project-X can have the same IP address from the project IP CIDR 172.16.0.0/16. However, two VMs in the same project cannot have the same IP address from the project IP CIDR 172.16.0.0/16. For example, although VM 104(2) and VM 104(6) belong to different VPCs, both VM 104(2) and VM 104(6) belong to project-1; thus, an IP address allocated to VM 104(2) (e.g., IP address 172.16.0.3) is different than an IP address allocated to VM 104(6) (e.g., IP address 172.16.1.5). Each project subnet is allocated one or more IP addresses from the project IP CIDR block. For example, subnet-2 of VPC-1 in project-1 is allocated IP addresses in CIDR block 172.16.0.0/24, which is a portion of the IP addresses in the project IP CIDR block 172.16.0.0/16. Further, subnet-5 of VPC-2 also in project-1 is allocated IP addresses in CIDR block 172.16.1.0/24, which is a different portion of the IP addresses in the project IP CIDR block 172.16.0.0/16, such that VMs in subnet-5 are not assigned the same IP addresses as VMs in subnet-2.

IP addresses in public IP CIDR block 10.1.0.0/16 are reserved for public subnets in each given org. For example, all IP addresses in public IP CIDR block 10.1.0.0/16 can be assigned to VMs in org-1, and all IP addresses in public IP CIDR block 10.1.0.0/16 can also be assigned to VMs in another org not illustrated in FIG. 4, but part of the example multi-tenant architecture 800. Each public subnet is allocated one or more IP addresses from the public IP CIDR block. For example, subnet-3 of VPC-1 is allocated IP addresses in CIDR block 10.1.2.0/24, which is a portion of the IP addresses in the public IP CIDR block 10.1.0.0/16. Further, subnet-6 of VPC-2 is allocated IP addresses in CIDR block 10.1.1.0/24, which is another portion of the IP addresses in the public IP CIDR block 10.1.0.0/16.

As shown, each subnet includes one or more VMs 104(1-8). The number of VMs assigned to each subnet may depend on a number of subnet port objects defined (e.g., via subnet port custom resources) for architecture 800. VMs assigned to each subnet are assigned IP addresses from an IP CIDR block of the subnet. For example, VM 104(1), assigned to private subnet-1, is assigned IP address 192.168.0.5, which is an IP address in the private IP CIDR block 192.168.0.0/24 assigned to private subnet-1.

A VM assigned to a private subnet is only directly addressable by its assigned IP address from the private IP CIDR block within the VPC itself. For the VM to be addressable outside the VPC, NAT (e.g., static NAT, dynamic NAT, port-level multiplexed NAT, overlapping NAT, etc.) is used. For example, VM 104(1) may be addressed by its private IP address when VM 104(1) is the destination of a packet sent from another VM also assigned to private subnet-1 (e.g., not shown within FIG. 4) given both VMs are within the same VPC (e.g., VPC-1). However, VM 104(1) may not be directly addressed by its private IP address when VM 104(1) is the destination of a packet sent from VM 104(5) (e.g., part of private subnet-4 of VPC-2). Instead, VPC Gateway 806(1) is configured to perform source NAT (SNAT) for egress packets sent from VMs in subnet-1 to destinations outside subnet-1, and perform destination NAT (DNAT) for ingress packets sent to VMs in subnet-1 from destinations outside subnet-1. For example, VPC Gateway 806(1) is configured to perform NAT to translate private IP addresses in the private IP CIDR block to IP address 10.5.0.1 (a public IP address in a NAT CIDR block 10.5.0.0/16 reserved for NAT in org-1). Accordingly, for VM 104(5) to send a packet to VM 104(1), VM 104(5) may include in the packet the destination IP address 10.5.0.1 and a corresponding destination port number associated with VM 104(1). Based on the destination IP address 10.5.0.1, the packet is routed to VPC gateway 806(1), which based on NAT tables, translates the destination IP address 10.5.0.1 and destination port number to destination IP address 192.168.0.5, and sends the packet with the destination IP address 192.168.0.5 to VM 104(1). Accordingly, each VPC gateway 806 is configured to perform DNAT for ingress packets with a destination address associated with the VPC gateway 806 that is in the NAT CIDR block (e.g., IP address 10.5.0.1 for VPC gateway 806(1) and IP address 10.5.0.2 for VPC gateway 806(2)) to a corresponding private IP address in a private subnet in the VPC associated with the VPC gateway 806. Further, each VPC gateway 806 is configured to perform SNAT for egress packets with a source address in a private subnet in the VPC associated with the VPC gateway 806 and a destination address outside a private subnet in the VPC associated with the VPC gateway 806.

Similarly, a VM assigned to a project subnet is only directly addressable by its assigned IP address from the project IP CIDR block within the project itself. For example, VM 104(6) assigned to project subnet-5 is directly addressable by its project IP address 172.16.1.5 by VM 104(2) also within a project subnet (e.g., project subnet-2). For a VM assigned to a project to be addressable outside the project, NAT is used. Accordingly, each project gateway 804 is configured to perform DNAT for ingress packets with a destination address associated with the project gateway 804 that is in the NAT CIDR block (e.g., IP address 10.5.0.4 for project gateway 804(1)) to a corresponding project IP address in a project subnet in the project associated with the project gateway 804. Further, each project gateway 804 is configured to perform SNAT for egress packets with a source address in a project subnet in the project associated with the project gateway 804 and a destination address outside a project subnet in the project associated with the project gateway 804.

Further, a VM assigned to a public subnet is only directly addressable by its assigned IP address from the public IP CIDR block within the org itself. For the VM to be addressable outside the org, NAT is used. For example, each org gateway 804 is configured to similarly perform NAT for the org.

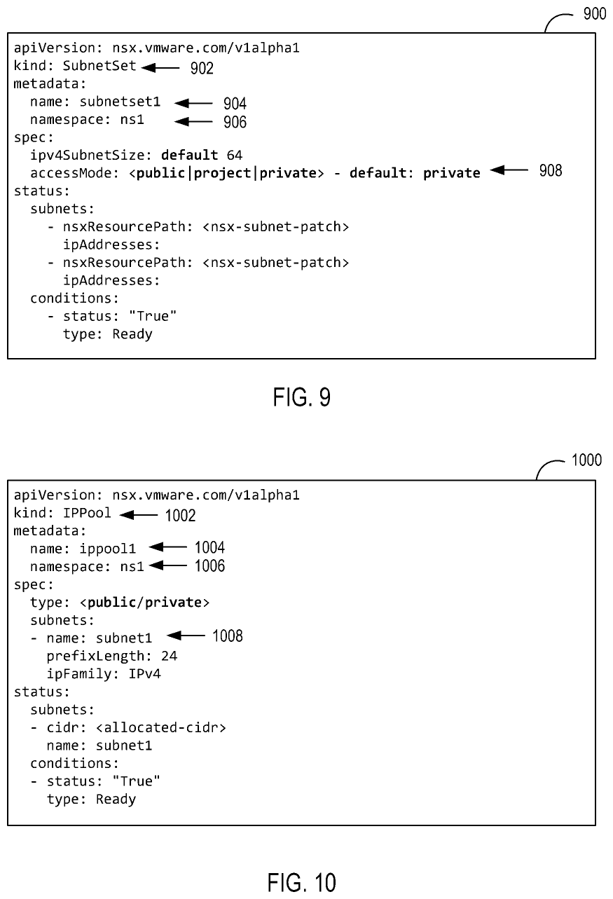

FIG. 9 illustrates an example SubnetSet CRD template 900 used to create a subnet custom resource for a container-based deployment (e.g., type of custom resource defined as “kind: SubnetSet” at 902). Unlike example subnet CRD 600 illustrated in FIG. 6, also used to create a subnet in the container-based deployment, for example subnet set CRD 900, a user is not required to specify a subnet CIDR. Instead, when scaling up in the container-based deployment, a new subnet may be allocated IP addresses from an IP block created for a public IP block or private IP CIDR associated with the VPC, based on a connectivity mode/access mode intended for the subnet.

As illustrated at 904 and 906, example SubnetSet CRD template 900 includes fields for specifying a name, for example, “subnetset1,” and a namespace, for example, “ns1,” for the subnet set custom resource. Further, SubnetSet CRD template 900 may include a field, “accessMode” at 908, for specifying a connectivity mode of the SubnetSet custom resource. The subnet created from the SubnetSet custom resource may be created with a public, project, or private connectivity mode as illustrated by “accessMode: <public|project|private>” at 908. Because example CRD template 900 is an example SubnetSet CRD template instead of an example Subet CRD template, IP addresses assigned to the subnet may be allocated to the subnet instead of specified by a user in SubnetSet CRD template 900.

FIG. 10 illustrates an example IP pool CRD 1000 used to create an IP pool custom resource for allocating a range of IP addresses belonging to a VPC's IP pool to a subnet (e.g., type of custom resource defined as “kind: IPPool” at 1002). As illustrated at 1004 and 1006, example IP pool CRD 1000 includes fields for specifying a name, for example, “ippool1,” and a namespace, for example, “ns1,” for the IP pool custom resource. Further, IP pool CRD 1000 may include the name of a subnet (e.g., at 1008) for which the IP addresses of the VPC's IP pool are to be allocated to. The subnet created for the IP pool custom resource might be from a public IP block or a private IP Block associated with a VPC, based on a type intended for the IP pool.

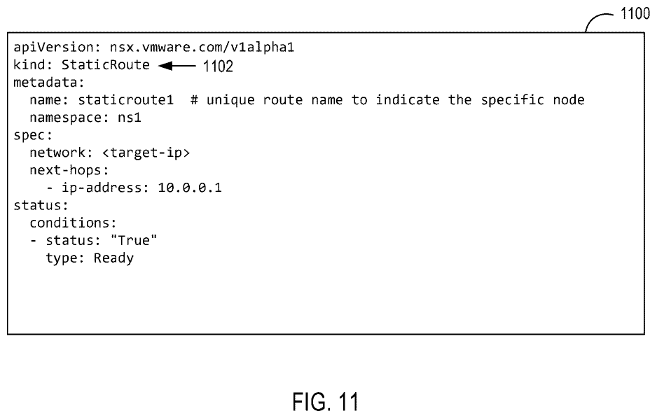

FIG. 11 illustrates an example static route CRD used to create a static route custom resource to define a static route, on a VPC, to enable use of the route to a network via a next-hop IP address (e.g., type of custom resource defined as “kind: StaticRoute” at 1102).

It should be understood that, for any process described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www. docker. com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method for creating one or more virtual private clouds for containerized workloads within a namespace in a networking environment of a container-based cluster, comprising:
deploying, on a container-based cluster, a virtual private cloud network configuration custom resource specifying network settings for configuring one or more virtual private clouds within the namespace;
deploying, on the container-based cluster, a virtual private cloud custom resource specifying first parameters for creating a virtual private cloud, wherein the first parameters comprise at least an indication of the namespace where the virtual private cloud is to be created; and
modifying a state of the container-based cluster to match a first intended state of the container-based cluster at least specified in the virtual private cloud custom resource and the virtual private cloud network configuration custom resource, wherein modifying the state comprises:
creating, by the container-based cluster, the virtual private cloud in the namespace based on the first parameters specified in the virtual private cloud custom resource; and
configuring, by the container-based cluster, the virtual private cloud based on the network settings specified in the virtual private cloud network configuration custom resource.

2. The method of claim 1, wherein the network settings specified in the virtual private cloud network configuration custom resource comprise at least one of:
an intended default gateway path for the one or more virtual private clouds,
an intended edge cluster path for the one or more virtual private clouds,
a default subnet size for one or more subnets created within the one or more virtual private clouds,
an identifier of a network virtualization management platform, or
a default subnet connectivity mode for the one or more subnets created within the one or more virtual private clouds, wherein the default subnet connectivity mode determines whether internet protocol (IP) addresses associated with the one or more subnets are addressable within a given virtual private cloud where the one or more subnets are created, within a first level isolation construct that includes the given virtual private cloud, or within a second level isolation construct that includes the given virtual private cloud and the first level isolation construct.

3. The method of claim 2, wherein:
the network settings specified in the virtual private cloud network configuration custom resource comprise the default subnet connectivity mode for the one or more subnets, and
the default subnet connectivity mode specified for the one or more subnets comprise a private connectivity mode, a public connectivity mode, or a project connectivity mode.

4. The method of claim 1, wherein the first parameters further comprise information about usage of at least one of a private classless inter-domain routing (CIDR) or a public CIDR for the virtual private cloud.

5. The method of claim 4, wherein creating the virtual private cloud in the namespace based on the first parameters specified in the virtual private cloud custom resource comprises:
assigning a range of IP addresses from at least one of the private CIDR or the public CIDR to the virtual private cloud; and
associating the range of IP addresses assigned to the virtual private cloud with the namespace, wherein one or more resources created in the namespace are instantiated in the range of IP addresses.

6. The method of claim 1, wherein:
the networking environment is divided into one or more first level isolation constructs;
each of the one or more first level isolation constructs is divided into one or more second level isolation constructs; and
each of the one or more second level isolation constructs is divided into at least one virtual private cloud, including the virtual private cloud created in the namespace.

7. The method of claim 1, further comprising:
deploying, on the container-based cluster, a subnet custom resource specifying second parameters for creating a subnet within the virtual private cloud; and
modifying the state of the container-based cluster to match a second intended state of the container-based cluster at least specified in the subnet custom resource, wherein modifying the state comprises creating, by the container-based cluster, the subnet in the virtual private cloud based on the second parameters specified in the subnet custom resource.

8. The method of claim 7, further comprising:
deploying a subnet port custom resource used to assign a node to the subnet created in the virtual private cloud; and
modifying the state of the container-based cluster to match a third intended state of the container-based cluster at least specified in the subnet port custom resource, wherein modifying the state comprises assigning the node to the subnet in the networking environment.

9. A system comprising:
one or more processors; and
at least one memory, the one or more processors and the at least one memory configured to:
deploy, on a container-based cluster, a virtual private cloud network configuration custom resource specifying network settings for configuring one or more virtual private clouds within a namespace in a networking environment of a container-based cluster;
deploy, on the container-based cluster, a virtual private cloud custom resource specifying first parameters for creating a virtual private cloud, wherein the first parameters comprise at least an indication of the namespace where the virtual private cloud is to be created; and
modify a state of the container-based cluster to match a first intended state of the container-based cluster at least specified in the virtual private cloud custom resource and the virtual private cloud network configuration custom resource, wherein to modify the state comprises to:
create, by the container-based cluster, the virtual private cloud in the namespace based on the first parameters specified in the virtual private cloud custom resource; and
configure, by the container-based cluster, the virtual private cloud based on the network settings specified in the virtual private cloud network configuration custom resource.

10. The system of claim 9, wherein the network settings specified in the virtual private cloud network configuration custom resource comprise at least one of:
an intended default gateway path for the one or more virtual private clouds,
an intended edge cluster path for the one or more virtual private clouds,
a default subnet size for one or more subnets created within the one or more virtual private clouds,
an identifier of a network virtualization management platform, or
a default subnet connectivity mode for the one or more subnets created within the one or more virtual private clouds, wherein the default subnet connectivity mode determines whether internet protocol (IP) addresses associated with the one or more subnets are addressable within a given virtual private cloud where the one or more subnets are created, within a first level isolation construct that includes the given virtual private cloud, or within a second level isolation construct that includes the given virtual private cloud and the first level isolation construct.

11. The system of claim 10, wherein:
the network settings specified in the virtual private cloud network configuration custom resource comprise the default subnet connectivity mode for the one or more subnets, and
the default subnet connectivity mode specified for the one or more subnets comprise a private connectivity mode, a public connectivity mode, or a project connectivity mode.

12. The system of claim 9, wherein the first parameters further comprise information about at least one of private classless inter-domain routing (CIDR) usage or public CIDR usage for the virtual private cloud.

13. The system of claim 9, wherein:
the networking environment is divided into one or more first level isolation constructs,
each of the one or more first level isolation constructs is divided into one or more second level isolation constructs, and
each of the one or more second level isolation constructs is divided into at least one virtual private cloud, including the virtual private cloud created in the namespace.

14. The system of claim 9, wherein the one or more processors and the at least one memory are further configured to:
deploy, on the container-based cluster, a subnet custom resource specifying second parameters for creating a subnet within the virtual private cloud; and
modify the state of the container-based cluster to match a second intended state of the container-based cluster at least specified in the subnet custom resource, wherein modifying the state comprises creating, by the container-based cluster, the subnet in the virtual private cloud based on the second parameters specified in the subnet custom resource.

15. The system of claim 14, wherein the one or more processors and the at least one memory are further configured to:
deploy a subnet port custom resource used to assign a node to the subnet created in the virtual private cloud; and
modify the state of the container-based cluster to match a third intended state of the container-based cluster at least specified in the subnet port custom resource, wherein modifying the state comprises assigning the node to the subnet in the networking environment.

16. A non-transitory computer-readable medium comprising instructions that, when executed by one or more processors of a computing system, cause the computing system to perform operations for creating one or more virtual private clouds for containerized workloads within a namespace in a networking environment of a container-based cluster, the operations comprising:
deploying, on a container-based cluster, a virtual private cloud network configuration custom resource specifying network settings for configuring one or more virtual private clouds within the namespace;
deploying, on the container-based cluster, a virtual private cloud custom resource specifying first parameters for creating a virtual private cloud, wherein the first parameters comprise at least an indication of the namespace where the virtual private cloud is to be created; and
modifying a state of the container-based cluster to match a first intended state of the container-based cluster at least specified in the virtual private cloud custom resource and the virtual private cloud network configuration custom resource, wherein modifying the state comprises:
creating, by the container-based cluster, the virtual private cloud in the namespace based on the first parameters specified in the virtual private cloud custom resource; and
configuring, by the container-based cluster, the virtual private cloud based on the network settings specified in the virtual private cloud network configuration custom resource.

17. The non-transitory computer-readable medium of claim 16, wherein the network settings specified in the virtual private cloud network configuration custom resource comprise at least one of:
an intended default gateway path for the one or more virtual private clouds,
an intended edge cluster path for the one or more virtual private clouds,
a default subnet size for one or more subnets created within the one or more virtual private clouds,
an identifier of a network virtualization management platform, or
a default subnet connectivity mode for the one or more subnets created within the one or more virtual private clouds, wherein the default subnet connectivity mode determines whether internet protocol (IP) addresses associated with the one or more subnets are addressable within a given virtual private cloud where the one or more subnets are created, within a first level isolation construct that includes the given virtual private cloud, or within a second level isolation construct that includes the given virtual private cloud and the first level isolation construct.

18. The non-transitory computer-readable medium of claim 17, wherein:
the network settings specified in the virtual private cloud network configuration custom resource comprise the default subnet connectivity mode for the one or more subnets, and
the default subnet connectivity mode specified for the one or more subnets comprise a private connectivity mode, a public connectivity mode, or a project connectivity mode.

19. The non-transitory computer-readable medium of claim 16, wherein the first parameters further comprise information about at least one of private classless inter-domain routing (CIDR) usage or public CIDR usage for the virtual private cloud.

20. The non-transitory computer-readable medium of claim 16, wherein:
the networking environment is divided into one or more first level isolation constructs,
each of the one or more first level isolation constructs is divided into one or more second level isolation constructs, and
each of the one or more second level isolation constructs is divided into at least one virtual private cloud, including the virtual private cloud created in the namespace.
